(19) United States
(12) Patent Application Publication
(10) Pub. No.: US 2006/0144803 A1
(43) Pub. Date: Jul. 6, 2006

(54) Device and method for separation of blood components in bags, as well as the associated blood bag cups

(76) Inventor: Guenter Eberle, Tuttlingen (DE)

Correspondence Address: BAKER & DANIELS LLP;111 E. WAYNE STREET, SUITE 800, FORT WAYNE, IN, 46802, US

(21) Appl. No.: 11/231,048

(22) Filed: Sep. 20, 2005

(30) Foreign Application Priority Data
Sep. 21, 2004 (EP) 04022381.0

(51) Int. Cl. C02F 1/38

(52) U.S. Cl. 210/787; 494/1; 210/86; 210/512.1; 210/744; 494/10; 604/8; 604/10

(57) ABSTRACT

A device and a method for the separation of blood components in bags, as well as an associated blood bag cup. The device comprises a cup holder for a special double cup with two single cups and a double chamber each, whereby in one chamber of each of the two single cups at least one collection bag and at least one inflatable bag is inserted and in the other chamber of each of the two single cups at least one associated satellite bag connected via connecting hoses to the collection bag for the separated blood plasma is inserted. The device comprises a sensor for the detection of the separation layer between the separated blood components in the connecting hoses between the collection bag and the associated satellite bag. An extremely high degree of separation with e.g. maximum plasma yield, with purer plasma and time savings results.

The invention relates to a device and a method for the separation of blood components in bags, as well as an associated blood bag cup, in accordance with the generic term of the independent patent claims.

In the following only a separation of full blood in blood plasma and erythrocytes (red blood cells) will be described, which however, is not intended to be restrictive for the invention. Of course the invention can also be used for an additional separation of blood components that have already been separated, for example to manufacture blood platelet concentrate out of pooled buffy coats. For this reason any separation of one or more blood component(s) of full blood or of any mixture of several blood components should be comprised by the inventive concept.

Understood as state of the art is a conventional flexible collection bag filled with blood/blood components and a satellite bag for the reception of a separated blood component connected to the flexible bag via a connecting hose and if necessary a nutrient solution bag, whereby the bags are jointly placed in a conventional (double)blood bag cup and centrifuged. After that the bags are taken out of the cup and hung open individually in a squeezing device and the blood components are separated from one another by means of squeezing.

The disadvantage to this process is the fact that during centrifuging the bags press hard on each other and on the side of the cup (in particular on the bottom of the cup) and after centrifuging is complete a relatively great force and dexterity must be applied in removing the bags from the cup and in separating the bags from each other, which leads to a risk of damaging the bags and hoses and leads to relatively undesirable shaking of the collection bag and along with it the separation layer between the separated blood components. As a result the separated blood components partially mix together again in the region of the separation layer and the ratio of volumes of the separated blood components to each other changes, that is, the degree of separation sinks undesirably. Another disadvantage is the fact that the bags in particular in an incompletely filled state do not fit optimally in the cup and as a result folds and with them groups of sedimentation can form during centrifugation.

Therefore it is the object of the invention to improve a device and a method for the separation of blood components in bags as well as an associated blood bag cup in such a way that the degree of separation is increased due to the fact that the blood components separated from one another by centrifugation in the collection bag remain separated from one another as stably as possible via the separation layer until their complete separation from each other by means of a squeezing device and do not mix back together again, or only insignificantly.

The features of the independent patent claims serve the purpose of solving the problem.

Essential in this connection for the device for the separation of blood components in bags is the fact that the device comprises a cup holder for a special double cup with two single cups and a double chamber each, whereby in the one chamber of each of the two single cups at least one collection bag and at least one inflatable bag can be inserted and in the other chamber of each of the two single cups at least one associated satellite bag connected via connecting hoses to the respective collection bag for the separated blood plasma (and if necessary for a nutrient solution to be supplied to the collection bag) can be inserted, whereby the cup holder possesses compressed air supplies with check valves for the two bags and furthermore the device comprises at least one pump for the inflating of the inflatable bags adjacent to the collection bags and furthermore the device comprises at least one sensor, preferably one sensor each for the detection of the separation layer between the separated blood components in the connecting hoses between the collection bags and the associated satellite bags.

In particular the pump for the inflation of the inflatable bags is constructed as a centrifugal pump, but can also be a reciprocating piston pump or a diaphragm pump or the like, whose speed of rotation determines the prevailing pressure in the inflatable bags.

Clocked triggered magnetic clamp valves are optionally provided, via which the connecting hoses are guided between the collection bags and the satellite bags so that the flow rate can be precisely controlled so that the separation layer in the collection bag remains stable and no turbulent mixing comes into being.

Furthermore, it is optionally provided that the inflatable bags adjacent to the collection bags can be inflated two at least two different pressure levels p1 and p2, so that the inflatable bags for one thing can be easily inflated to p1 prior to centrifugation and the collection bags with this press against the side of the cup in order to prevent the formation of folds and sedimentation clusters and for another thing the inflatable bags can be inflated to an increased pressure p2>p1, in order to squeeze the blood components within the collection bag from each other via the separation layer after centrifugation and therefore to completely separate said blood components, whereby the separated blood components are collected in one of the satellite bags.

In particular for the two pressures p1 and p2 within the device there are two different positions of the cup provided, which in particular are achieved by means of a movable longitudinal slide on which the cup holder and the cup with the bags is located. Preferably the lower pressure p1 for the “preliminary tensioning” of the bags is assigned to an extended position of the longitudinal slide, with the higher pressure p2 for the squeezing or separation of the blood components from each other.

Furthermore the device preferably possesses a vertically extending suspension frame for the satellite bag, whereby first hooks for the bag of the separated blood components and second hooks for the bag containing a nutrient solution are provided, whereby the bag for the nutrient solution is vertically higher than the bag for the separated blood components since the nutrient solution in particular is driven only via gravity and is fed into the collection bag by means of one of the clocked solenoid clamp valves.

The functions “Start”, Solenoid Valve” and “Reset” each have a control element provided

In this connection, the following steps are important for the method of separating blood components in bags:
1. Equipping of the double-chamber double-cup with the collection and satellite bags,
2. Insertion of the double-chamber double-cup into the device for the separation of blood components in bags and inflation of the inflatable bags to a lower pressure p1, until the collection bags are full in their respective chambers of the double-chamber double-cup,
3. Removal of the double-chamber double-cup from the device and insertion into a suitable centrifuge and centrifuging,
4. Reinsertion of the double-chamber double-cup into the device,
5. Removal of the satellite bags from the double-chamber double-cup and positioning of the satellite bags in such a way that the connecting hoses are guided between the collection bags and the satellite bags for the separated blood components via at least one sensor, in particular one sensor each, for the detection of the separation layer,
6. Opening of the safety shutoff valves between the collection bag and the associated satellite bag,
7. Inflating of the inflatable bags to an upper pressure p2, until the separation layer in the collection bag has migrated into the connecting hoses between the collection bags and the satellite bags to the sensor which ends the inflation operation of the inflatable bags,
8. Separation of the associated satellite bags for the separated blood components from the collection bags and/by means of closing, in particular bonding,
9. Optional filling of nutrient solution into the collection bags and separation of the associated satellite bags for the nutrient solution from the collection bags and/by means of closing, in particular bonding,
10. Removal of the collection bags from the double-chamber double-cup, as well as removal of the satellite bags from the device.

The inflatable bags are only removed from the chambers of the double-chamber double-cup in the case of a defect or for cleaning purposes, therefore they can remain in the cup as a rule.

The inflating of the inflatable bags takes place in this connection in particular via at least one centrifugal pump, whose speed of rotation determines the prevailing pressure in the inflatable bag.

The supplying of the nutrient solution from the satellite bag for the nutrient solution into the collection bag takes place in this connection in particular via gravitational force, but can also take place by means of a pump in another embodiment.

The volume flow rate of the blood components to be separated (e.g., blood plasma) is in particular regulated in this connection via clocked solenoid clamp valves, in order to keep the separation layer stable.

The volume flow rate of the nutrient solution is optionally also regulated via clocked solenoid clamp valves.

However, the solenoid clamp valves can also be dropped in another embodiment.

In this connection, it is essential for the cup for the separation of the blood components in the bags that it is constructed as a double-chamber double-cup with two cups, and that each cup is constructed with two chambers separate from each other, one chamber for the collection and inflatable bags and one chamber for the satellite bags.

The two cups are in particular mirror-symmetrical and permanently attached to each other by a handle.

The two chambers of the two cups of the double-cup for the collection and inflatable bags are preferably indirectly or directly adjacent to each other, and the chambers for the satellite bags are arranged further apart from each other.

The respective chamber for the satellite bags is constructed to be hinged and locking so that a chamber flap is linked via a hinge on the other cup. In particular the hinge axis is horizontal in the cup, but can also be vertical.

An in particular rotating constructed hose guide is arranged between the adjacent chambers of the double-cup, which simultaneously serves as a guide for the connecting hoses between the bags during the centrifuging and during the squeezing (separation of the blood components in the device), as a result of which the connecting hoses undergo a vertical alignment.

The shutoff valves are arranged in the region of the handle preferably underneath on the handle for supplying compressed air to the inflatable bags.

The advantages of the afore-mentioned device and of the method for the separation of blood components in bags, as well as of the associated blood bag cup are an extremely high degree of separation with e.g. maximum plasma yield, with purer plasma and a time savings of over 50% due to the double construction of the double-chamber double-cup.

In contrast to the squeezing devices which have been standard up to now, which are post-connected to a conventional blood centrifugation, here double the number, namely two blood bags, can be squeezed at one time, which corresponds to cutting the work time in half.

Furthermore, unlike the state of the art up to now, the blood bags do not have to be removed from the centrifuge cups and individually suspended open into the squeezing device. The removal of the cups which has been necessary up to now requires that one pulls very hard because the blood bags had been compressed into the cups very tightly and free from air. This is no longer the case with the inventive double-flap cup, the bags remain in there. Even by means of the most careful work it was not reliably possible to avoid turbulence, that is, a mixing of the outer layers of the sediments.

In the inventive double-flap cup two separately connected empty air bags are mounted underneath the handle, whose air supply is closed by the handle upon being placed upon the slide and which is activated by the press of a button. In the extended position the double-cup can be supplied with a pre-selectable and set air pressure of approximately 0.2 bar. This is applied prior to centrifugation, in order to squeeze the inserted blood bag tightly and to prevent a formation of folds with groups of sedimentation. The compressed air supply on the handle has two shutoff valves, which maintain the air pressure during removal.

After centrifugation the double-cup is lowered and inserted with the slide onto the squeeze position, through which a force of pressure of 0.5 bar per button press can occur. With each lowering of the cups on the slide the shutoff valves are opened.

The satellite bags, i.e. as a rule one empty bag for the plasma and one additional bag with up to 110 ml of nutrient solution for the remaining packed human blood cells as well as the connecting hoses, are placed easily into the lateral flap parts which are closed for centrifugation and can be opened after centrifugation, in order to ensure easy handling. The satellite bags also have a tendency of sticking to the bottom. Thus removal from the opened cups is much easier and effortless.

The flap parts themselves have a hinge at the bottom with an oblong hole and two longitudinal hooks on both sides at the top, with which they can be easily moved down for non-positive locking and up for opening.

A wing that can be swiveled by 90° is mounted above the handle, said wing which stands for loading in the longitudinal direction as shown in the figure and is turned by 90° in order to keep the connecting hose to the satellite bag in a vertical position and to prevent a kinking of the hose.

The inventive device has a wire frame with suspension hooks in which the satellite bags are hanged. The collection bag for the plasma is placed on the lower hook while the nutrient bag for the packed human blood cells goes on the upper hook. The supply lines are guided over the vertically arranged sensors and further over the pressure valves. This has the important advantage that the squeeze flow of the plasma takes place in extensively vertical arrangement up to the sensor, which results in a prevention of the formation of streaks and in a far better yield of plasma.

The inventive device is a blood component separator in particular for the automatic separation of plasma and erythrocyte concentrate from pre-filtered banked blood in T&T blood bag systems or for the manufacturing of blood platelet concentrates out of pooled buffy coats.

In the use of conventional separators the centrifuged banked blood must be removed from the centrifuge cups and attached to the squeezing device. In the process the sediment can get fluidized again. The inventive device on the other hand squeezes the banked blood directly in the centrifuge cup.

Advantages: Squeezing takes place directly in the centrifuge unit. No fluidization of the sediments caused by removal of the bag from the centrifuge units after centrifugation. Purer plasma. Simpler handling. Time savings: 2 units of banked blood are squeezed simultaneously. Space savings: Compact design. Takes up little space in comparison to conventional separators. Maximum plasma yield by means of positioning of the sensor on the hose.

In the present invention it is a matter of giving a known soft blood bag the tautest possible fixation, which from the beginning prevents formation of folds, in order to prevent the development of sediment traps in the folds. For this purpose the filled blood bag is placed in the hinged insert cup, which is provided on the inside with an empty air bag. The hinged auxiliary cup holds the satellite bag and the hoses of the blood bag system and is closed with the partition, resulting in a compact, closed cup half or insert half, which is connected to a second half via a handle, resulting in a double-cup blood bag unit, as has been used similarly in practice for a long time. With the help of an air pump the two air bags are slightly inflated, until the blood gabs no longer show any more folds. After that the double inserts are placed into the metal cups of the centrifuge for centrifuging.

In the centrifugation the air in the air bags is displaced and forms an air bubble which stabilizes the connecting pieces of the hoses and prevents buckling, which also prevents the development of unpleasant sediment traps.

The connecting hoses can additionally be trimmed via floating stabilization clips to the vertical position upon exiting the blood bag, which also prevents buckling and the development of sedimentation traps.

After successful centrifugation the double insert cups are removed from the centrifuge, the two auxiliary cups are opened and the satellite bags attached to the connecting hoses are taken out.

Both air bags are further inflated simultaneously via an air pump and the protruding plasma in the blood bag is displaced into the satellite bags, as can be precisely performed in this way to gain pooled blood platelets.

Advantage: The centrifuged blood bag must not be carefully or forcefully pulled out of its receptacle, as a result of which more or less a takes place, but rather the components remain preserved up to separation with sharp separating lines.

An unpleasant formation of folds and buckling of the connecting pieces, in particular in the case of underfilled bags, is prevented.

In the following the invention will be described in greater detail with the help of drawings depicting only one means of implementation. In this connection, additional features and advantages of the invention result from the drawings and their description.

The figures show the following:

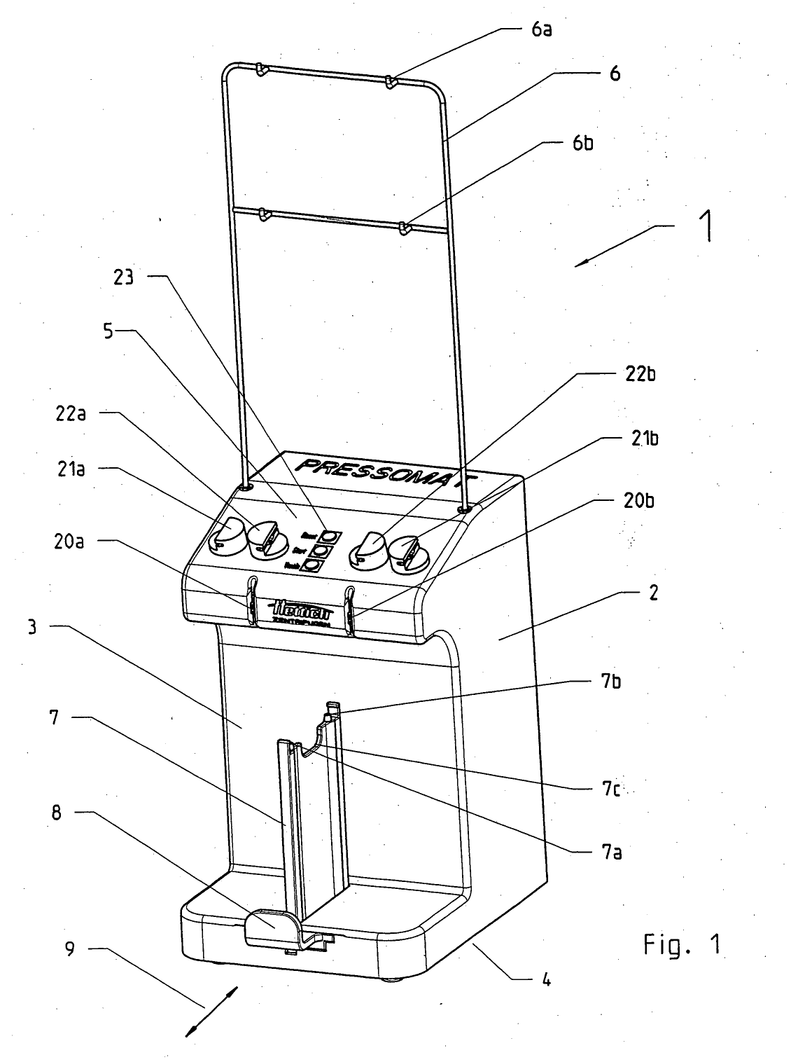

FIG. 1: shows a perspective view of an inventive device for the separation of blood components in bags, without showing an associated blood bag cup;

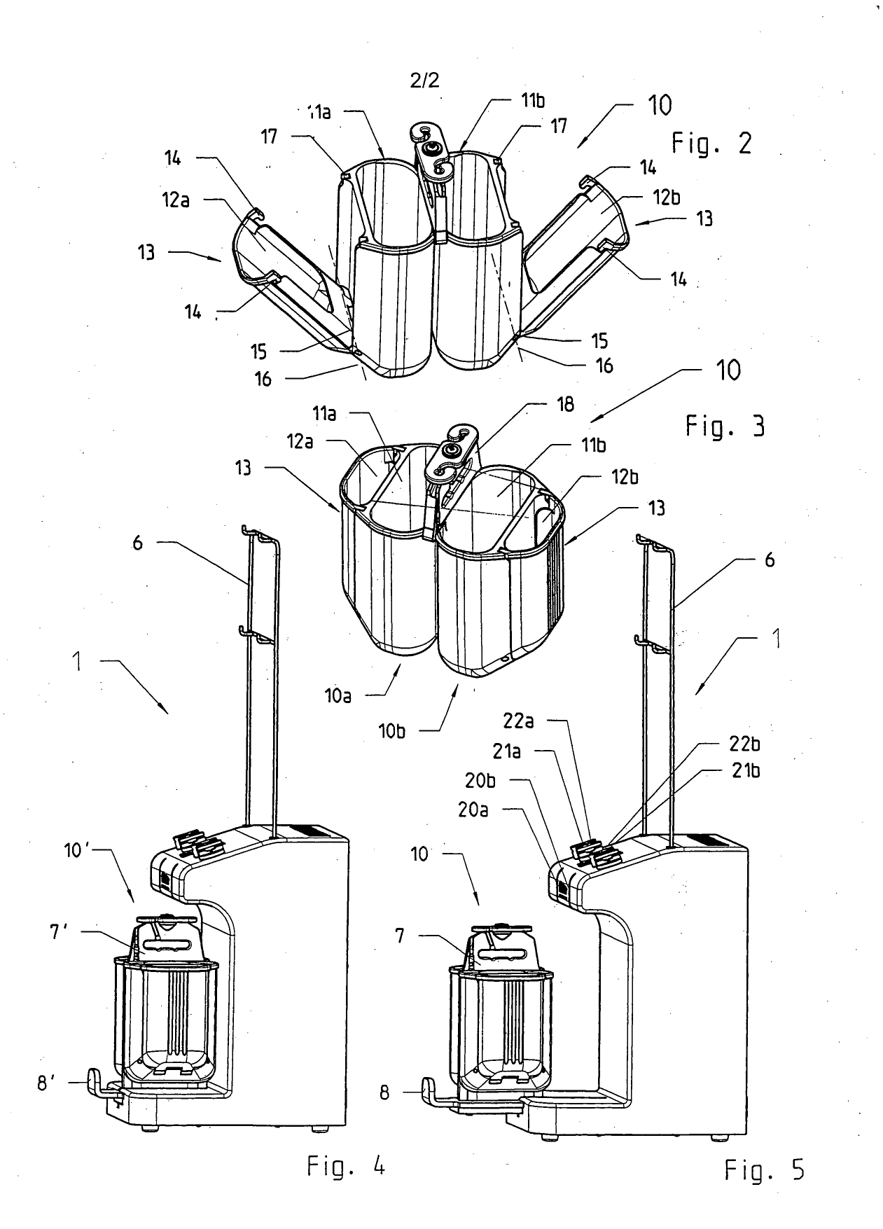

FIG. 2: shows a perspective view of an inventive blood bag cup in opened position;

FIG. 3: shows a perspective view of an inventive blood bag cup in accordance with FIG. 2 in closed position;

FIG. 4: shows a perspective view of an inventive device in accordance with FIG. 1, with representation of an associated blood bag cup in accordance with FIGS. 2 and 3 in a first position;

FIG. 5: shows a device in accordance with FIG. 4, with representation of an associated blood bag cup in accordance with FIGS. 2 and 3 in a second position.

In accordance with FIG. 1 the inventive device 1 for the separation of blood components in bags consists of a case 2 and a suspension frame 6 mounted to the case from its head for the hanging of the nutrient solution bag on the upper hook 6a and for the hanging of the plasma bag on the lower hook 6b, whereby the suspension frame 6 is formed in the shape of the letter “A”.

The case 2 has a bulge 3 in the front region for the cup holder 7 and consists additionally of a bottom 4 and of a top region 5, as well as consisting of sidewalls and rear walls.

In the top region 5 there are four solenoid clamp valves 21, 22 present, two of them (21a, 22b) for the clamping of the connecting hose between the collection and satellite bags and two further bags (22a, 22b) for the clamping of the connecting hose between the collection and nutrient solution bags. In the front of the top region 5 there are vertical slots underneath each of the solenoid clamp valves 21, in which sensors 20 (20a, 20b) are arranged in about the middle for the detection of the in the respective connecting hose between the collection and satellite bags. Three actuating elements 23 are provided between the solenoid clamp valves 21, 22 in the top region 5, for “Start”, “Solenoid valve on/off” and for “Reset”.

The cup holder 7 is designed for holding an inventive double cup 10 in accordance with FIGS. 2 and 3, whereby the top, button-shaped connections 7a, 7b are molded on for the air supply of the inflatable bag. If the double cup 10 is placed as per FIGS. 2 and 3 on the cup holder 7 in such a way that a single cup 10a comes to rest on the one side and the other single cup 10b comes to rest on the other side of the cup holder 7, then the connections 10a, 10 attach for the air supply of the inflatable bags to check valves of the single cups 10a, 10b, whereby these check valves are connected to the inflatable bags (not shown here) in the outer chambers 11a, 11b (see FIGS. 2, 3) of the single cups 10a, 10b.

The whole cup holder 7 is supported on a slide 8 which is constructed in the sliding directions 9 to be moved manually or by a motor out of/into the bulge 3, so that the positions in accordance with FIGS. 5 and 5 result. FIG. 4 shows the slide 8 in its extended position, which is provided for the purpose of inflating the inflatable bags with a lower initial pressure (prior to centrifugation), in order to squeeze the collection and the inflatable bags compact in the chamber 11a, 11b. FIG. 5 shows the slide 8 in its retracted position, which is provided for the purpose of inflating the inflatable bags with a higher end pressure (after centrifugation) in order to completely separate the centrifuged blood components from each other by squeezing a portion out of the collection bag by means of the inflatable bag.

FIGS. 2 and 3 show an inventive double hinged cup 10, in opened position (FIG. 2) and in closed position (FIG. 3).

The inventive double hinged cup 10 consists of two cups 10a, 10b, which are mirror-symetrically attached to each other either indirectly or directly, detachably or non-detachably, via a handle 18 with their chambers 11a, 11b for the collection and inflatable bags. A chamber 12a, 12b for the satellite bags connects to the respective chambers 11a, 11b for the removal and inflatable bags, which each have a hinged flap part 13. This flap part 13 is swivel connected around an axis by means of a hinge 15 with the remainder of the chambers 12a, 12b, which in turn are connected to chambers 11a, 11b. The flap part 13 is secured during by hooks 14, which lock into engagement in the allocated retainers 17.

All of the chambers 11, 12 are constructed open at the top and closed at the bottom, so that the respective bags can be easily inserted.

Above the handle 18 a rotating hose guide 19 is arranged around a normal axis, which is designed to be swiveled in a horizontal plane. The connecting hoses (not shown) are held in an expedient vertical position between the collection and satellite bags (not shown) by means of hook-shaped ends of the hose guide 19, so that an optimum, unhindered passage of liquid is made possible during the squeezing of the blood components to be separated, but also for the prevention of the sealing of groups of non-separated blood components (e.g. groups of erythrocytes).

### LEGEND

1. Device for the separation of blood components in bags
2. Case
3. Bulge
4. Bottom
5. Top region
6. Suspension frame; 6a Hook for nutrient solution, 6b hook for plasma
7. Cup holder; 7a, b air supply, 7c recess
8. Slide for 7
9. Extension/retraction direction of 8
10. Double cup; 10a first single cup; 10b second single cup
11. Chambers separated from 12 for collection bag and inflatable bag; 11a for first single cup; 11b for second single cup
12. Hinged chambers for holding the satellite bags
13. Flap part of 12
14. Hook of 12
15. Hinge between 11 and 12
16. Axis of 15
17. Retainers of 14
18. Handle
19. Hose guide
20. Sensor for separation layer, left: 20a, right: 20b
21. Solenoid clamp valve for collection bag, left: 21a, right: 21b
22. Solenoid clamp valve for nutrient solution bag, left: 22a, right: 22b
23. Actuating elements

1. Device for the separation of blood components in bags characterized by the fact that the device comprises a cup holder for a special double cup with two single cups and a double chamber for each cup, whereby in the one chamber at least one collection bag and at least one inflatable bag can be inserted in each of the two single cups and in the other chamber at least one associated satellite bag for the separated blood plasma (and if necessary for a nutrient solution to be supplied to the collection bag) connected via connecting hoses to the respective collection bag can be inserted into each of the two single cups, whereby the cup holder has compressed air supplies with check valves for the two inflatable bags and furthermore the device comprises at least one pump for the inflating of the inflatable bags adjacent to the collection bags and furthermore the device comprises at least one sensor, preferably one sensor each for the detection of the separation layer between the separated blood components in the connecting hoses between the collection bags and the associated satellite bags.

2. Device in accordance with claim 1, characterized by the fact that the pump for the inflation of the inflatable bags is constructed as a centrifugal pump, a reciprocating piston pump or a diaphragm pump, whose speed of rotation determines the prevailing pressure in the inflatable bags.

3. Device in accordance with claim 1, characterized by the fact that clocked triggered magnetic clamp valves are provided, via which the connecting hoses are guided between the collection bags and the satellite bags so that the flow rate can be precisely controlled

4. Device in accordance with claim 1, characterized by the fact that the inflatable bags adjacent to the collection bags can be inflated two at least two different pressure levels p1 and p2, so that the inflatable bags for one thing can be easily inflated to p1 prior to centrifugation and the collection bags with this press against the side of the cup (10) in order to prevent the formation of folds and sedimentation clusters and for another thing the inflatable bags can be inflated to an increased pressure p2>p1, in order to squeeze the blood components within the collection bag from each other via the separation layer after centrifugation and therefore to completely separate said blood components, whereby the separated blood components are collected in one of the satellite bags.

5. Device in accordance with claim 1, characterized by the fact that for the two pressures p1 and p2 within the device there are two different positions of the cup provided, which in particular are achieved by means of a movable longitudinal slide on which the cup holder and the cup with the bags is located.

6. Device in accordance with claim 5, characterized by the fact that the lower pressure p1 for the “preliminary tensioning” of the bags is assigned to an extended position of the longitudinal slide, the cup holder and the cup and the higher pressure p2 for the squeezing or separation of the blood components from each other is assigned to the retracted position of the longitudinal slide, the cup holder and the cup.

7. Device in accordance with claim 1, characterized by the fact that the device preferably possesses a vertically extending suspension frame for the satellite bag, whereby first hooks for the bag of the separated blood components and second hooks for the bag containing a nutrient solution are provided, whereby the bag for the nutrient solution is vertically higher than the bag for the separated blood components since the nutrient solution in particular is driven only via gravity and is fed into the collection bag by means of one of the clocked solenoid clamp valves.

8. Method for the separation of blood components in bags with the device according to claim 1, characterized by the following steps:
Equipping of the double-chamber double-cup with the collection and satellite bags,
Insertion of the double-chamber double-cup into the device for the separation of blood components in bags and inflation of the inflatable bags to a lower pressure p1, until the collection bags are full in their respective chambers of the double-chamber double-cup,
Removal of the double-chamber double-cup from the device and insertion into a suitable centrifuge and centrifuging,
Reinsertion of the double-chamber double-cup into the device,
Removal of the satellite bags from the double-chamber double-cup and positioning of the satellite bags in such a way that the connecting hoses are guided between the collection bags and the satellite bags for the separated blood components via at least one sensor, in particular one sensor each, for the detection of the separation layer,
Opening of the safety shutoff valves between the collection bag and the associated satellite bag,
Inflating of the inflatable bags to an upper pressure p2, until the separation layer in the collection bag has migrated into the connecting hoses between the collection bags and the satellite bags to the sensor which ends the inflation operation of the inflatable bags,
Separation of the associated satellite bags for the separated blood components from the collection bags and/by means of closing, in particular bonding,
Optional filling of nutrient solution into the collection bags and separation of the associated satellite bags for the nutrient solution from the collection bags and/by means of closing, in particular bonding,
Removal of the collection bags from the double-chamber double-cup, as well as removal of the satellite bags from the device.

9. Method in accordance with claim 8, characterized by the fact that the inflatable bags are only removed from the chambers of the double-chamber double-cup in the case of a defect or for cleaning purposes, and that they remain in the cup as a rule.

10. Method in accordance with claim 8, characterized by the fact that the inflating of the inflatable bags takes place in particular via at least one centrifugal pump or reciprocating piston pump or diaphragm pump, whose speed of rotation determines the prevailing pressure in the inflatable bag.

11. Method in accordance with claim 8, characterized by the fact that the supplying of the nutrient solution from the satellite bag for the nutrient solution into the collection bag takes place solely via gravitational force.

12. Method in accordance with claim 8, characterized by the fact that the volume flow rate of the blood components to be separated (e.g., blood plasma) is regulated via clocked solenoid clamp valves, in order to keep the separation layer stable.

13. Method in accordance with claim 8, characterized by the fact that the volume flow rate of the nutrient solution is regulated via clocked solenoid clamp valves.

14. Cup for the separation of the blood components in bags for use in the device in accordance with claim 1, whereby the cup is constructed as a double cup with two single cups, characterized by the fact that each single cup of the double cup is constructed with two chambers separate from each other, one chamber for the collection and inflatable bags and one chamber for the satellite bags.

15. Cup in accordance with claim 14, characterized by the fact that the respective chambers for the satellite bags can be locked via a chamber flap, which is linked via a hinge on the other cup around a vertical and/or horizontal hinge axis.

16. Cup in accordance with claim 14, characterized by the fact that between the adjacent chambers of the double-cup a hose guide is provided, which in particular is constructed to be rotating and which serves as a guide for the connecting hoses between the bags, whereby as a result the connecting hoses undergo a vertical alignment.

17. Cup in accordance with claim 14, characterized by the fact that the two cups are mirror-symmetrically adjacent to each other.

18. Cup in accordance with claim 14, characterized by the fact that the two cups are attached to each other by a handle.

19. Cup in accordance with claim 14, characterized by the fact that the two chambers of the two cups of the double cup for the collection and inflatable bags are preferably indirectly or directly adjacent to each other, and the chambers for the satellite bags are arranged further apart from each other.

20. Cup in accordance with claim 14, characterized by the fact that the shutoff valves for supplying compressed air to the inflatable bags are arranged in the region of the handle preferably underneath on the handle.

21. Cup for the separation of the blood components in bags for use in the device in accordance with the method as per claim 8, whereby the cup is constructed as a double cup with two single cups, characterized by the fact that each single cup of the double cup-is constructed with two chambers separate from each other, one chamber for the collection and inflatable bags and one chamber for the satellite bags.
